(19) United States
(12) Patent Application Publication
(10) Pub. No.: US 2016/0379275 A1
(43) Pub. Date: Dec. 29, 2016

(54) SYSTEM AND METHOD FOR BUYING ADVERTISING INVENTORY

(71) Applicant: Vizury Interactive Solutions Pvt Ltd, Bangalore (IN)

(72) Inventor: Mansoor Alicherry, Bangalore (IN)

(73) Assignee: Vizury Interactive Solutions Pvt Ltd

(21) Appl. No.: 14/747,007

(22) Filed: Jun. 23, 2015

(51) Int. Cl. G06Q 30/02

(52) U.S. Cl. CPC G06Q 30/0275

(57) ABSTRACT

The embodiments herein provide a system and computer-implemented method for buying an advertising inventory. The method includes receiving at least one rule book from a plurality of Demand Side Platform's (DSPs) when a user visits a web page. Further, the method includes selecting a DSP from the plurality of DSPs to buy the advertising inventory based on the at least one rule book.

### TECHNICAL FIELD

The embodiments herein generally relate to bidding systems and more particularly for buying advertising inventory in real-time bidding system or non-real-time bidding systems.

### BACKGROUND

Real-Time Bidding (“RTB”) is a recent development in programmatically buying and selling online advertising space (i.e., inventory). Generally, a Demand Side Platform (DSP) such as a trading desk can be used by buyers of ad space. The DSP may interact with a third party entity called an exchange that hosts an exchange server supporting the RTB. In some instances, the exchange may also subsume the role of the DSP.

In conventional RTB mechanisms as shown in FIG. 1a, when the user, using a personal computing device such as a desktop computer, laptop, tablet, or cell phone navigates to or “visits” the publisher's webpage, the publisher may wish to derive revenue from the user's visit by selling advertising inventory located on the publisher's webpage. In such an instance, an advertisement (ad) tag request may be generated and can be transmitted, directly or indirectly, by the browser to the exchange.

After receiving the ad tag request, the exchange sends a bid request to the DSP bidding engine. The DSP bidding engine sends a bid response to the exchange after receiving the bid request. After receiving the bid response, the exchange sends an ad tag response to the browser. The browser sends an ad request to the DSP ad server. After receiving the ad request, the DSP ad server sends an ad response to the browser for programmatically buying advertising inventory. Generally, the RTB provides flexibility for the DSPs to buy inventory from the exchange i.e., when and where to show ads and how much to pay for the ads. Moreover, the RTB requires complex infrastructure at the exchange and DSP to meet stringent latency requirements and scale.

In conventional Non-RTB mechanisms as shown in FIG. 1b, the ad tag request may be generated and can be transmitted, directly or indirectly, by the browser to the exchange. After receiving the ad tag request, the exchange sends the ad tag response to the browser. The browser sends the ad request to the DSP ad server. After receiving the ad request, the DSP ad server sends the ad response to the browser for buying advertising inventory as shown in the FIG. 1b. In contrast to the RTB, the non-RTB exchanges are simple thereby, providing faster ad response and bandwidth saving for ad exchange. Further, the non-RTB exchanges are non-programmatic and inflexible on the controls provided to the DSPs. This is, no control over where the ad is shown and no control over the ad price.

In both RTB mechanisms and Non-RTB mechanisms, pixelling (i.e., informing the exchange about interest in a specific type of user) is performed initially as shown in FIG. 1c. Whenever the user is visiting the web page of an advertiser, the DSP tags are fired as shown in the FIG. 1c. The DSP tags in turn fire “Partner Pixels” thereby, informing the exchange about the DSP interest in the user. In case of RTB mechanism, along with the interest notification, a cookie matching request is sent to the exchange. After receiving the interest notification along with the cookie matching request, the exchange matches the cookie identifiers (id's) of the exchange and DSP. Further, the exchange sends the interest notification response to the browser. Optionally, in case of RTB mechanism, a cookie matching response is sent to the DSP as shown in the FIG. 1c. After receiving the cookie matching response, the DSP transmits a response “OK” message to the browser.

Thus, there is a need in the art to for a simple and robust system and method for buying advertising inventory in real-time bidding system or non-real-time bidding systems without incurring the complexities of the RTB infrastructure.

The above information is presented as background information only to help the reader to understand the present invention. Applicants have made no determination and make no assertion as to whether any of the above might be applicable as Prior Art with regard to the present application.

### BRIEF DESCRIPTION OF THE FIGURES

This invention is illustrated in the accompanying drawings, throughout which like reference letters indicate corresponding parts in the various figures. The embodiments herein will be better understood from the following description with reference to the drawings, in which:

FIG. 1a illustrates a conventional bidding system for facilitating programmatic buying of advertising inventory on a Real Time Bidding (RTB) exchange;

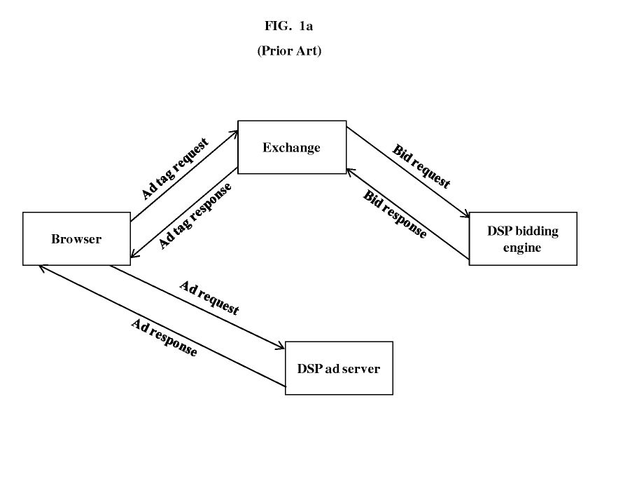

FIG. 1b illustrates another conventional bidding system for facilitating Non-programmatic buying of advertising inventory on a Non-RTB exchange;

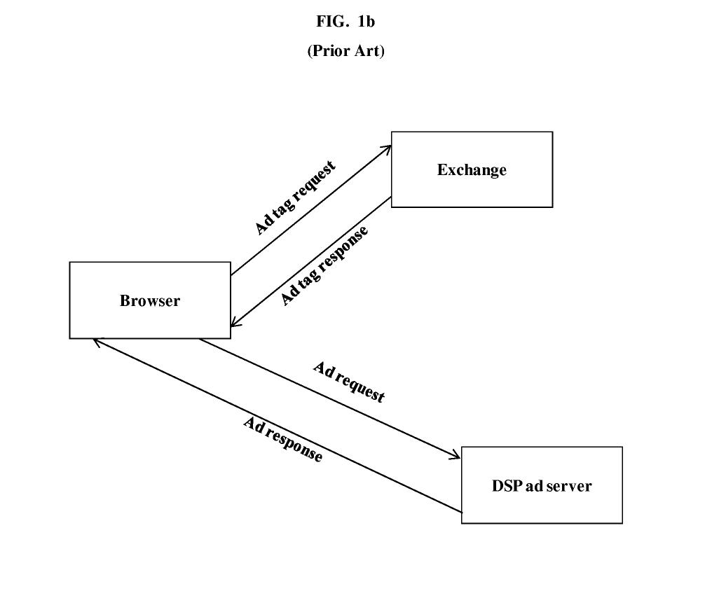

FIG. 1c illustrates another conventional bidding system for facilitating pixelling in the RTB and Non-RTB exchanges;

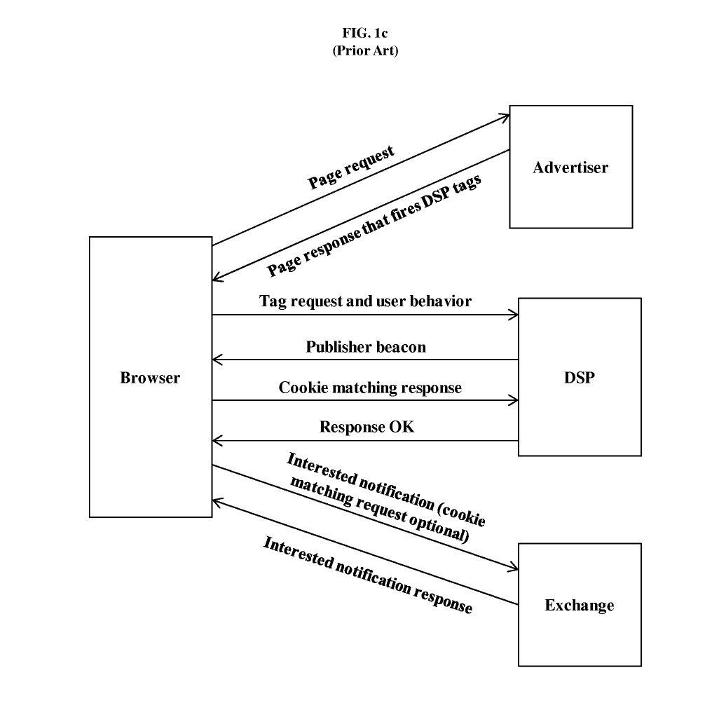

FIG. 2 illustrates a bidding system for facilitating programmatic buying of advertising inventory, according to embodiments as disclosed herein;

FIG. 3 illustrates a bidding system for serving advertisements (ads) to a user, according to embodiments as disclosed herein;

FIG. 4 illustrates another bidding system for buying advertising inventory using Precise Audience Measurement (PAM), according to embodiments as disclosed herein;

FIG. 5 is a flow diagram illustrating a method for facilitating programmatic buying of advertising inventory, according to embodiments as disclosed herein; and

FIG. 6 illustrates a computing environment implementing the method for facilitating programmatic buying of advertising inventory, according to embodiments as disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as not to unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Prior to describing the present invention in detail, it is useful to provide definitions for key terms and concepts used herein. Unless defined otherwise, all technical and scientific terms used herein have the same meaning as commonly understood by one of ordinary skill in the art to which this invention belongs.

Real Time Bidding (RTB): Non-exclusively refers to a mechanism in which advertising inventory is bought and sold on a per-impression basis, via programmatic instantaneous auction, similar to financial markets. RTB lets advertisers manage and optimize ads from multiple ad-networks by granting the user access to a multitude of different networks, allowing them to create and launch advertising campaigns, prioritize networks and allocate percentages of unsold inventory, known as backfill.

Non-RTB: Non-exclusively refers to a mechanism in which advertising inventory is bought and sold on a per-impression basis via offline mode.

Exchange: Exchange provides a platform for buying and selling advertising impressions by consolidating and managing impression opportunities across a plurality of publishers.

Demand Side Platforms (DSPs): It enables buyers to connect directly to multiple sources of inventory supply and provide such benefits as workflow simplification, integrated reporting, programmatic buying optimization, and the ability to make impression-level bids (RTB).

The embodiments herein disclose a computer-implemented method and system for buying an advertising inventory. The computer-implemented method includes receiving, at an exchange, at least one rule book from a plurality of Demand Side Platform's (DSPs) when a user visits a web page. In an embodiment, the user can visit the web page of an advertiser. In another embodiment, the user can visit the web page of a publisher. In another embodiment, the user can visit any web page where the DSP tags are present. Further, the method includes selecting, by the exchange, a DSP from the plurality of DSPs to buy the advertising inventory based on the at least one rule book.

In an embodiment, the rule book defines a plurality of conditions based on which the DSP buys the advertising inventory.

In an embodiment, the plurality of conditions are defined based on at least one of a DSP bid value, number of impressions, publisher website information, time of the day, a day of a year, type of inventory such as banner size, animation supported, location of the banner (top, bottom, side etc.), a variable defined by the exchange, and a variable defined by the DSP. In another embodiment, the plurality of conditions is defined based on a user behavior on the web page.

In an embodiment, the DSP is selected based on analysis of each rule book received from each DSP, wherein the analysis is performed to identify whether each condition of the rule book corresponding to the DSP is met.

In an embodiment, the at least one rule book is received by the exchange in redirection of a uniform resource identifier (URI), wherein the URI comprises DSP tags to identify at least one DSP.

In an embodiment, the webpage includes the tags corresponding to each DSP, where each tag indicates corresponding DSP interest in the user. In an embodiment, the tag is a pixel tag.

In the conventional systems and methods, the RTB requires complex infrastructure at the exchange and the DSP to meet stringent latency requirements and scale. In contrast to the RTB, the non-RTB exchanges are non-programmatic and inflexible on the controls provided to the DSPs i.e., no control over where the ad is shown and no control over the ad price.

Unlike the conventional systems and methods, a simple and robust mechanism for programmatic buying of advertising inventory on the non-RTB exchanges without incurring the complexities of the RTB infrastructure is proposed. The proposed method and system provides flexibility of buying non-RTB inventory without incurring the complexities of the RTB infrastructure. The proposed method and system reduces the complex infrastructure for exchange and the plurality of DSPs, reduces the bandwidth requirement for the exchange, and need not require stringent latency requirements.

Unlike the conventional systems and methods, the proposed method and system provides fine control over where the advertisements to be displayed and fine control over the price. Further, by using rule book, it is possible for the plurality of DSPs not having RTB capability to participate in bidding process for buying advertising inventory. In this case, the exchange needs to evaluate rule book and bid on behalf of the DSP for buying advertising inventory. Further, the proposed system and method can be implemented using existing infrastructure and may not require extensive setup and instrumentation.

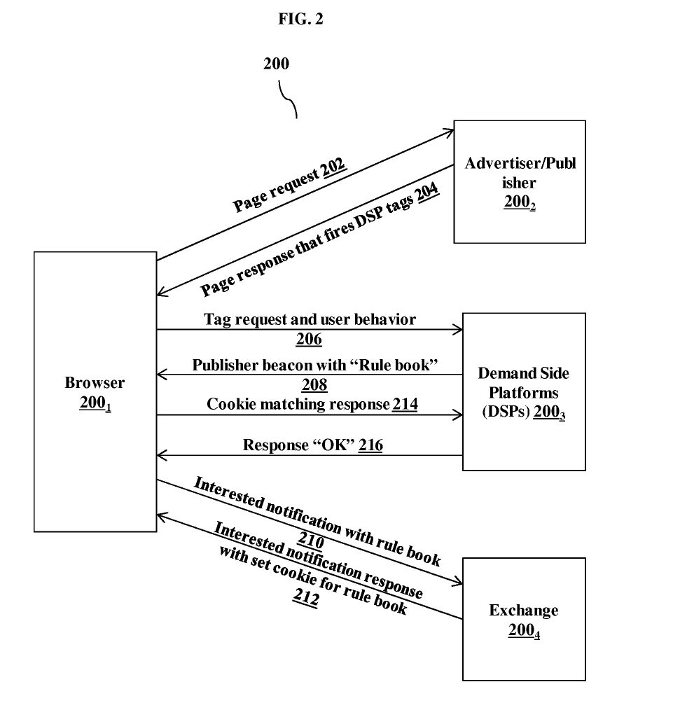

Referring now to the drawings, and more particularly to FIGS. 2 through 6, where similar reference characters denote corresponding features consistently throughout the figures, there are shown preferred embodiments.

FIG. 2 illustrates a bidding system 200 for facilitating programmatic buying of advertising inventory, according to embodiments as disclosed herein. The bidding system 200 includes a browser 200₁, an advertiser 200₂, a plurality of Demand Side Platforms (DSPs) 200₃, and an exchange 200₄. In an embodiment, the exchange 200₄ can be Real-Time Bidding (RTB) enabled Exchange. In another embodiment, the exchange 200₄ can be a Non-RTB enabled exchange. In an embodiment, the exchange 200₄ can include a processor, a controller, a microcontroller, microprocessor, or equivalent thereof for programmatic buying of the advertising inventory. Further, the exchange may include other modules or components interacting locally or remotely along with other hardware or software components to communicate with each other for programmatic buying of advertising inventory on the non-RTB exchanges without incurring the complexities of the RTB infrastructure.

At step 202: In an embodiment, a user, using the browser 200₁ in a personal computing device (not shown) such as a desktop computer, laptop, tablet, or cell phone transmits a page request message to the advertiser 200₂ when the user intends to visit a webpage of the advertiser 200₂. In another embodiment, the browser 200₁ transmits the page request message when the user intends to visit a webpage of the publisher 200₂. In another embodiment, the user can visit any web page where the DSP tags are present.

At step 204: After receiving the page request message, the advertiser 200₂ can transmit a page response command that fires DSP tags to the browser 200₁.

At step 206: The advertiser 200₂ can transmit a command to the browser 200₁ to redirect to the DSPs 200₃. For example, the advertiser 200₂ may return a HTTP redirect command when transmitting the page response; the redirect command may identify a uniform resource locator (URL) associated with the plurality of DSPs 200₃. After receiving the redirect command, the browser 200₁ redirects to the plurality of DSPs 200₃ and transmits the tag request message and user behavior information. In an embodiment, when the user navigates to the webpage of the advertiser 200₂, information pertaining to the user may be transmitted to the plurality of DSPs 200₃. For example, information collected by the user's web browser (“cookies”) may be transmitted to the plurality of DSPs 200₃. Such information may include the user's web browsing history, the frequency with which the user visits particular webpage or type of webpages, or the user's online purchase history. In another embodiment, the user's computing device may transmit information indicative of user's geographic location, IP address, or other information.

At step 208: After receiving the tag request and user behavior information, the plurality of DSPs 200₃ creates a rule book for what to bid for the user based on their behavior information. In an embodiment, the rule book defines a plurality of conditions based on which the DSP from the plurality of DSPs 200₃ buys the advertising inventory. In an example, the plurality of conditions are defined based on a DSP bid value, number of impressions, publisher website information, time of the day, a day of a year, type of inventory, a variable defined by the exchange 200₄, and a variable defined by the DSP. The plurality of conditions is defined based on the user behavior on the web page of the advertiser 200₂. Further, the browser 200₁ receives another redirect command along with a publisher beacon with the created rule book from the plurality of DSPs 200₃. Unlike the conventional systems, to avoid tampering with cookie, a signature in the rule book is included. The rule book can be signed with a private key of the DSP which can be verified by the exchange 200₄ using the DSPs public key.

At step 210: After receiving the redirect command, the browser 200₁ redirects to the exchange 200₄ and transmits an interested notification with the created rule book. The exchange 200₄ receives the rule book created by the plurality of DSPs 200₃ in the form of a browser redirection. In an embodiment, the exchange 200₄ stores the rule book of each DSP in its cookie at the browser 200₁. In another embodiment, the exchange 200₄ stores the rule book of each DSP at a server.

At step 212: The exchange 200₄ transmits interested notification response with set cookie for rule book to the browser 200₁. In case of RTB enabled exchange 200₄, in addition to the above described sequence of steps, below described steps are also performed for buying advertising inventory.

At step 214: In the interest notification response, there is a cookie matching where the exchange 200₄ matches the cookie identifiers (id's) of the exchange 200₄ and the plurality of DSPs 200₃. Further, the exchange 200₄ sends a cookie matching response in the form of a browser redirection to the DSP among the plurality of DSPs 200₃ after determining the match.

At step 216: After receiving the cookie matching response, the DSP among the plurality of DSPs 200₃ transmits a response “OK” message to the browser 200₁.

The FIG. 2 illustrates a limited overview of the system 200 but, it is to be understood that other embodiments are not limited thereto. The system 200 may include other modules or components interacting locally or remotely along with other hardware or software components to communicate with each other for programmatic buying of advertising inventory on the non-RTB exchanges without incurring the complexities of the RTB infrastructure.

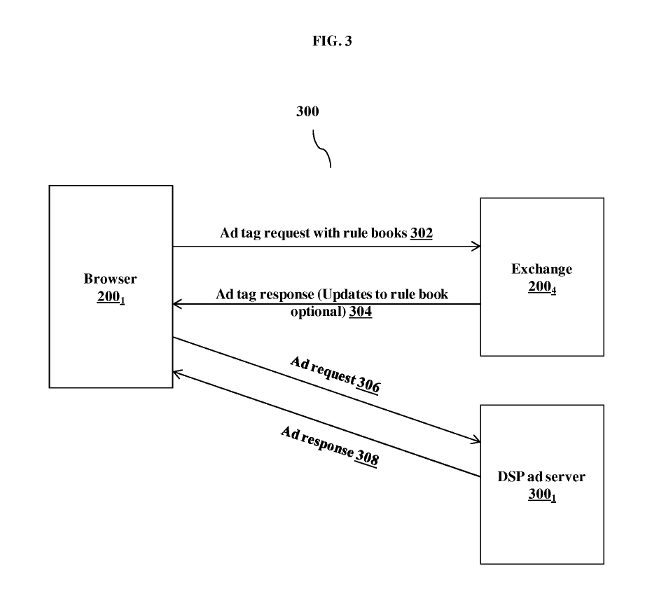

FIG. 3 illustrates a bidding system 300 for serving advertisements (ads) to the user, according to embodiments as disclosed herein. The bidding system 300 includes the browser 200₁, the exchange 200₄, and a DSP advertisement (ad) server 300₁. In an embodiment, the exchange 200₄ can be the RTB enabled exchange. In another embodiment, the exchange 200₄ can be the Non-RTB enabled exchange. As shown in the FIG. 3, the interactions between the browser 200₁, the exchange 200₄, and the DSP ad server 300₁.

At step 302: While serving the ads, the exchange 200₄ receives the rule book from the plurality of DSPs 200₃ along with the ad tag request.

At step 304: After receiving the rule books, the exchange 200₄ evaluates the rule books and selects the optimal DSP (i.e., highest paying DSP) among the plurality of DSPs 200₃ and calls its ad tag. In an embodiment, the exchange 200₄ may update the rule book such as number of impressions served. Further, the exchange may pass the updated rule book to the DSP ad server 300₁ in the form of the browser redirection. In an embodiment, the rule book evaluation can be performed at the browser 200₁ (i.e., client side). Unlike conventional systems, performing the rule book evaluation at the browser 200₁ would require less compute resources for the exchange 200₄ however, the evaluation logic needs to be sent to the browser 200₁ in the form of a java script. In another embodiment, the rule book evaluation can be performed at the exchange 200₄.

At step 306: The ad request can be redirected to the DSP ad server 300₁ which serves the relevant ad for the user.

At step 308: The DSP ad server 300₁ transmits the ad response to the browser 200₁. Further, the DSP ad server 300₁ can update the rule book. The updated rule book can be used during next cycle when the ad is served by the exchange 200₄.

The FIG. 3 illustrates a limited overview of the system 300 but, it is to be understood that other embodiments are not limited thereto. The system 300 may include other modules or components interacting locally or remotely along with other hardware or software components to communicate with each other for serving advertisements (ads) to the user based on an analysis of the rule book received from each DSP.

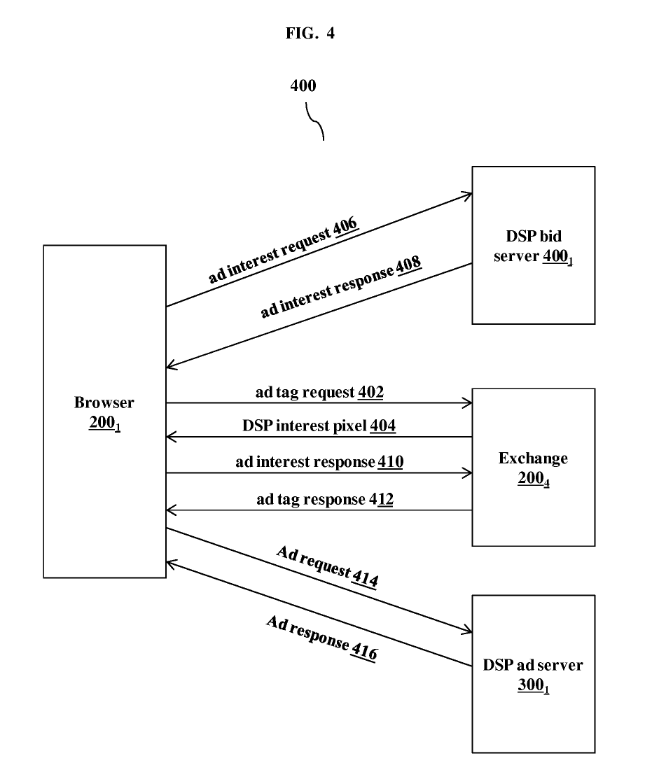

FIG. 4 illustrates a bidding system 400 for buying advertising inventory using Precise Audience Measurement (PAM), according to embodiments as disclosed herein. In an embodiment, the bidding system 200 includes the browser 200₁, the exchange 200₄, a DSP advertisement (ad) server 300₁, and the DSP bid server 400₁. As shown in the FIG. 4, the interactions among the browser 200₁, the exchange 200₄, the DSP ad server 300₁, and the DSP bid server 400₁.

At step 402: The browser 200₁ transmits the ad tag request to the exchange 200₄.

At step 404: After receiving the ad tag request, the exchange 200₄ transmits a DSP interest pixel to the browser 200₁.

At step 406: The exchange 200₄ transmits the command to the browser 200₁ to redirect to the DSP bid server 400₁. The browser 200₁ sends an ad interest request to the DSP bid server 400₁.

At step 408: After receiving the ad interest request, the DSP bid server 400₁ sends an ad interest response to the browser 200₁.

At step 410: The browser 200₁ redirects the ad interest response to the exchange 200₄. Unlike conventional systems, the exchange 200₄ selects the DSP that has shown the interest and has maximum pay. The amount that DSP can pay for the impression is negotiated in advance and there is no bidding for the price.

At step 412: The exchange 200₄ sends the ad tag response to the browser 200₁.

At step 414: The ad request can be redirected by the browser 200₁ to the DSP ad server 300₁ which serves the relevant ad for the user.

At step 416: The DSP ad server 300₁ transmits the ad response to the browser 200₁.

Unlike the conventional systems, the precise audience measurement (PAM) allows the DSP to buy advertising inventory from the publisher on a first look basis. This is similar to RTB, but with following differences instead of the bid request from the exchange 200₄, the ad interest request is sent from the browser 200₁ to the DSP bid server 400₁.

Further, in an embodiment, PAM can be enhanced to provide more flexibility and efficiency with the use of rule book. In the ad interest response message (at step 408), the DSP bid server 400₁ sends the rule book, instead of “YES” or “NO” response. The rule book can specify the price of the impressions that the DSP is willing to pay as well as rules on the interested on the user (e.g., Time of day, publisher web URL, etc.) with price information. Dynamic pricing for PAM with conditions (rules) on the interest can be provided and no need to check for the interest for every impression thereby, making protocol less bandwidth consuming and efficient. In an embodiment, in case of RTB mechanism, the DSP can send the rule book regarding when it is willing to pay for the impression. The exchange 200₄ needs to send the bid request when the conditions of the rule book are satisfied.

The FIG. 4 illustrates a limited overview of the system 300 but, it is to be understood that other embodiments are not limited thereto. The system 400 may include other modules or components interacting locally or remotely along with other hardware or software components to communicate with each other for buying advertising inventory using the PAM.

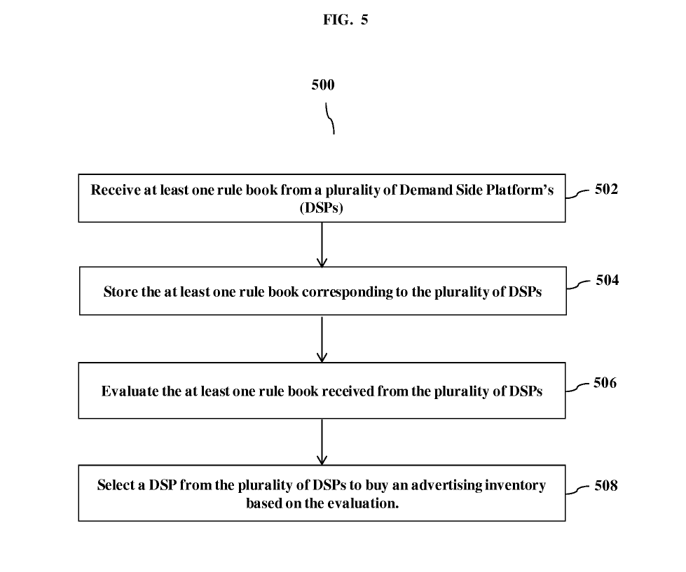

FIG. 5 is a flow diagram illustrating a computer-implemented method 500 for facilitating programmatic buying of advertising inventory, according to embodiments as disclosed herein. At step 502, the method 500 includes receiving the rule book from the plurality of DSPs 200₃. In an embodiment, the rule book is received from the plurality of DSPs 200₃ when the user visits the web page of the advertiser. In another embodiment, the rule book is received from the plurality of DSPs 200₃ when the user visits the web page of the publisher. In another embodiment, the rule book is received from the plurality of DSPs 200₃ when the user visits the web page where the DSP tags are present. The method 500 allows the exchange 200₄ to receive the rule book from the plurality of DSPs 200₃. In an embodiment, the web page includes the tags corresponding to each DSP, where each tag indicates corresponding DSP interest in the user. The tag is the pixel tag.

In an embodiment, the rule book defines the plurality of conditions based on which the DSP among the plurality of DSPs 200₃ buys the advertising inventory. The plurality of conditions are defined based on at least one of the DSP bid value, number of impressions, publisher website information, time of day, the day of the year, type of inventory, the variable defined by the exchange 200₄, and the variable defined by the plurality of DSPs 200₃. However, in an embodiment, the plurality of conditions is defined based on the user behavior on the web page of the advertiser. In another embodiment, the plurality of conditions is defined based on the user behavior on the web page of the publisher. In another embodiment, the rule book can include the bid value and no conditions. This would be a “Flat Bid” similar to the non-RTB mechanism but more dynamic than the non-RTB mechanism.

At step 504, the method 500 includes storing the at least one rule book corresponding to the plurality of DSPs 200₃. The method 500 allows the exchange 200₄ to store the at least one rule book corresponding to the plurality of DSPs 200₃. In an embodiment, the exchange 200₄ stores the rule book in its cookie at the browser 200₁. In another embodiment, the exchange 200₄ stores the rule book at the server.

At step 506, the method 500 includes evaluating the at least one rule book received from the plurality of the DSPs 200₃. The method 600 allows the exchange 200₄ to evaluate the at least one rule book received from the plurality of the DSPs 200₃. In an embodiment, the rule book evaluation can be performed either at the browser 200₁. The evaluation of the rule book performed at the browser 200₁ would require less computational resources for the exchange 200₄, but the evaluation logic needs to be sent to the browser 200₁ in the form of the java script. In another embodiment, the rule book evaluation can be performed at the exchange 200₄.

At step 508, the method 500 includes selecting the DSP from the plurality of DSPs 200₃ to buy the advertising inventory based on the evaluation. In an embodiment, the DSP is selected from the plurality of DSPs 200₃ to buy the advertising inventory corresponding to the advertiser 200₂. In an embodiment, the DSP is selected from the plurality of DSPs 200₃ to buy the advertising inventory corresponding to the publisher. In an embodiment, the DSP is selected based on analysis of each rule book received from each DSP. The analysis is performed to identify whether each condition of the rule book corresponding to the DSP is met.

The various actions, acts, blocks, steps, or the like in the method 500 may be performed in the order presented, in a different order or simultaneously. Further, in some embodiments, some of the actions, acts, blocks, steps, or the like may be omitted, added, modified, skipped, or the like without departing from the scope of the invention.

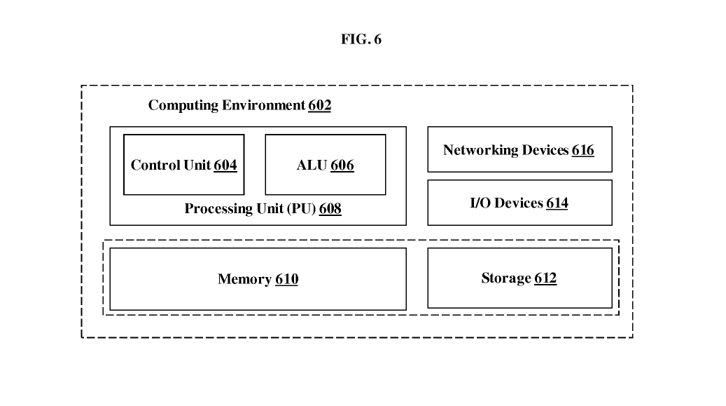

FIG. 6 illustrates a computing environment implementing the method for facilitating programmatic buying of advertising inventory, according to embodiments as disclosed herein. As depicted in the figure, the computing environment 602 comprises at least one processing unit 608 that is equipped with a control unit 604 and an Arithmetic Logic Unit (ALU) 606, a memory 610, a storage unit 612, plurality of networking devices 616 and a plurality Input output (I/O) devices 614. The processing unit 608 is responsible for processing the instructions of the technique. The processing unit 608 receives commands from the control unit in order to perform its processing. Further, any logical and arithmetic operations involved in the execution of the instructions are computed with the help of the ALU 606.

The overall computing environment 602 can be composed of multiple homogeneous and/or heterogeneous cores, multiple CPUs of different kinds, special media and other accelerators. The processing unit 608 is responsible for processing the instructions of the technique. Further, the plurality of processing units 608 may be located on a single chip or over multiple chips.

The technique comprising of instructions and codes required for the implementation are stored in either the memory unit 610 or the storage 612 or both. At the time of execution, the instructions may be fetched from the corresponding memory 610 or storage 612, and executed by the processing unit 608.

In case of any hardware implementations various networking devices 616 or external I/O devices 614 may be connected to the computing environment to support the implementation through the networking unit and the I/O device unit.

The embodiments disclosed herein can be implemented through at least one software program running on at least one hardware device and performing network management functions to control the elements. The elements shown in the FIGS. 2 through 6 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

I claim:

1. A computer-implemented method for buying an advertising inventory, the computer-implemented method comprising:
receiving, at an exchange, at least one rule book from a plurality of Demand Side Platform's (DSPs) when a user visits a web page; and
selecting, by said exchange, a DSP from said plurality of DSPs to buy said advertising inventory based on said at least one rule book.

2. The computer-implemented method of claim 1, wherein said at least one rule book defines a plurality of conditions based on which said DSP buys said advertising inventory.

3. The computer-implemented method of claim 2, wherein said plurality of conditions are defined based on at least one of a DSP bid value, number of impressions, publisher website information, time of the day, a day of a year, type of inventory, a variable defined by an exchange, and a variable defined by said plurality of DSPs.

4. The computer-implemented method of claim 3, wherein said plurality of conditions is defined based on a user behavior on said web page.

5. The computer-implemented method of claim 1, wherein said DSP is selected based on analysis of each said rule book received from each said DSP, wherein said analysis is performed to identify whether each condition of said rule book corresponding to said DSP is met.

6. The computer-implemented method of claim 1, wherein said at least one rule book is received by said exchange in redirection of a uniform resource identifier (URI), wherein said URI comprises DSP tags to identify at least one said DSP.

7. The computer-implemented method of claim 1, wherein said webpage comprises said tags corresponding to each said DSP, wherein each said tag indicate corresponding DSP interest in said user, wherein said tag is a pixel tag.

8. A bidding system for buying an advertising inventory, the bidding system comprising:
a plurality of Demand Side Platforms (DSPs), wherein each said DSP configured to send at least one rule book to an exchange; and
wherein said exchange configured to:
receive at least one rule book from said plurality of DSPs when a user visits a web page; and
select a DSP from said plurality of DSPs to buy said advertising inventory based on said at least one rule book.

9. The bidding system of claim 8, wherein said at least one rule book defines a plurality of conditions based on which said DSP buys said advertising inventory.

10. The bidding system of claim 9, wherein said plurality of conditions are defined based on at least one of a DSP bid value, number of impressions, publisher website information, time of a day, a day of a year, type of inventory, a variable defined by an exchange, and a variable defined by said plurality of DSPs.

11. The bidding system of claim 10, wherein said plurality of conditions is defined based on a user behavior on said web page.

12. The bidding system of claim 8, wherein said DSP is selected based on analysis of each said rule book received from each said DSP, wherein said analysis is performed to identify whether each condition of said rule book corresponding to said DSP is met.

13. The bidding system of claim 8, wherein said at least one rule book is received by said exchange in redirection of a Unique Resource Identifier (URI) associated with said advertiser, wherein said URI comprises DSP tags to identify at least one said DSP.

14. The bidding system of claim 8, wherein said webpage comprises said tags corresponding to each said DSP, wherein each said tag indicate corresponding to each said DSP, wherein each said tag indicate corresponding DSP interest in said user, wherein said tag is a pixel tag.

15. An exchange for buying an advertising inventory, the exchange configured to:
receive at least one rule book from a plurality of Demand Side Platform's (DSPs) when a user visits a web page; and
select a DSP from said plurality of DSPs to buy said advertising inventory based on said at least one rule book.

16. The exchange of claim 15, wherein said at least one rule book defines a plurality of conditions based on which said DSP buys said advertising inventory.

17. The exchange of claim 16, wherein said plurality of conditions are defined based on at least one of a DSP bid value, number of impressions, publisher website information, time of the day, a day of a year, type of inventory, a variable defined by an exchange, and a variable defined by said plurality of DSPs.

18. The exchange of claim 17, wherein said plurality of conditions is defined based on a user behavior on said web page.

19. The exchange of claim 15, wherein said DSP is selected based on analysis of each said rule book received from each said DSP, wherein said analysis is performed to identify whether each condition of said rule book corresponding to said DSP is met.

20. The exchange of claim 15, wherein said at least one rule book is received by said exchange in redirection of a uniform resource identifier (URI) associated with said advertiser, wherein said URI comprises DSP tags to identify at least one said DSP.

21. The exchange of claim 15, wherein said webpage comprises said tags corresponding to each said DSP, wherein each said tag indicate corresponding DSP interest in said user, wherein said tag is a pixel tag.
